(19) United States
(12) Patent Application Publication
(10) Pub. No.: US 2007/0095324 A1
(43) Pub. Date: May 3, 2007

(54) Vehicular air cleaner structure

(75) Inventors: Shinji Takahashi, Saitama (JP); Shinji Kawatani, Saitama (JP); Seiji Hanafusa, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/581,328

(22) Filed: Oct. 17, 2006

(30) Foreign Application Priority Data
Oct. 28, 2005 (JP) 2005-315063

(51) Int. Cl. F02M 35/02; F02M 25/00

(52) U.S. Cl. 123/198 E

(57) ABSTRACT

To improve throttle response and productivity of an air cleaner of a vehicle. A vehicular air cleaner structure is provided, in which an air cleaner is mounted to a vehicle body frame and an intake duct for drawing air in the air cleaner and a connecting tube for providing communication between the air cleaner and the side of an engine are connected to the air cleaner. The intake duct and the connecting tube are connected to the air cleaner. A connection rubber capable of being flexed by a change in pressure in the air cleaner is disposed on a side wall as at least one of walls of the air cleaner.

### CROSS-REFERENCE TO RELATED APPLICATIONS

The present application claims priority under 35 USC 119 to Japanese Patent Application No. 2005-315063 filed on Oct. 28, 2005 the entire contents of which are hereby incorporated by reference.

### BACKGROUND OF THE INVENTION

1. Field of the Invention

The present invention relates to an improved structure of a vehicular air cleaner.

2. Description of Background Art

A known example of a vehicular air cleaner structure includes an intake pipe, which draws air into an air cleaner case, and a connection pipe, which connects the air cleaner case to a carburetor with both being connected to the air cleaner case. See, for example, Japanese Patent Laid-open No. 2004-270559.

Referring to FIG. 3 of Japanese Patent Laid-open No. 2004-270559, an air cleaner case 53 has a single side wall that includes an intake pipe connection portion 61 that connects an intake pipe 51 and a connection pipe through hole 63 that supports a connection pipe 54 by letting it pass therethrough.

Referring to FIG. 1, the intake pipe 51 extends from a point downward of a front end of a seat 35 to the air cleaner case 53 disposed downward of the seat 35 at a center thereof.

The intake pipe 51 has a large air flow resistance because of its longer overall length. A filter disposed inside the air cleaner case 53 also has a large air flow resistance. When a throttle valve is suddenly opened during, for example, acceleration of a vehicle or the like, it becomes harder for the air to enter the air cleaner case 53 via the intake pipe 51. As a result, there is a drop in pressure in the air cleaner case 53. This impedes a good flow of air from an inside of the air cleaner case 53 toward the side of an engine. There is therefore a need for an improved response to an increase in an engine speed, that is, a throttle response by suppressing a drop in pressure inside the air cleaner case 53.

There is also a need for improving assemblability of the intake pipe 51 and the connection pipe 54 for an improved productivity, when the intake pipe 51 and the connection pipe 54 are connected to the intake pipe connection portion 61 and the connection pipe through hole 63, respectively, disposed in the side wall of the air cleaner case 53.

### SUMMARY AND OBJECTS OF THE INVENTION

It is therefore an object of the present invention to improve vehicular throttle response and productivity of air cleaners.

According to a first aspect of the present invention, there is provided an air cleaner structure for a vehicle. The structure includes an air cleaner disposed on a vehicle body frame. Further, the air cleaner includes an intake duct for drawing air in the air cleaner and a connecting tube for providing communication between the air cleaner and an engine side. The intake duct and the connecting tube are connected to the air cleaner.

The air cleaner structure according to a first embodiment of the present invention provides an air cleaner that includes an elastic body capable of being flexed by a change in pressure in the air cleaner. The elastic body is disposed on at least one of walls of the air cleaner.

An example of the effects achieved by a first embodiment of the present invention is, if the pressure inside the air cleaner is dropped when a throttle valve of an intake system is suddenly opened, the elastic body flexes into the air cleaner, thereby suppressing a substantial drop in pressure. Accordingly, air flows smoothly from the air cleaner to the engine side with a substantially little delay after the throttle valve is opened.

According to a second embodiment of the present invention, the intake duct and the connecting tube are supported by a single elastic body.

As an example of effects, the elastic body can be quickly and easily assembled to the air cleaner, as compared with an arrangement, in which an elastic body is provided separately for each of the intake duct and the connecting tube.

According to a third embodiment of the present invention, the vehicle includes a temperature sensor disposed on the air cleaner. The temperature sensor measures a temperature of air drawn into the air cleaner and the temperature sensor is supported by the elastic body.

As an example of effects, the elastic body can be quickly and easily assembled to the air cleaner as compared with an arrangement, in which another elastic body supporting the temperature sensor is assembled to the air cleaner.

According to a fourth embodiment of the present invention, the elastic body includes an elastic surface other than a support portion supporting the intake duct, the connecting tube, and the temperature sensor.

As an example of effects, a drop in pressure in the air cleaner is suppressed by the elastic surface other than the support portion supporting the intake duct, the connecting tube, and the temperature sensor.

According to the first embodiment of the present invention, the elastic body that is capable of being flexed by a change in pressure inside the air cleaner is disposed on at least one of the walls of the air cleaner. As a result, the elastic body suppresses an instantaneous pressure drop in the air cleaner when the throttle valve is suddenly opened. Air can thereby be drawn into the engine quickly and throttle response can be improved.

According to the second embodiment of the present invention, the intake duct and the connecting tube are supported by a single elastic body. The elastic body supporting the intake duct and the connecting tube can therefore be mounted at the same time. Assemblability can therefore be improved and productivity enhanced.

According to the third embodiment of the present invention, the vehicle includes the temperature sensor that measures the intake air temperature of the air cleaner and the temperature sensor is supported by the elastic body. This improves assemblability of the temperature sensor relative to the air cleaner and prevents vibration from being transmitted to the temperature sensor. Further, the elastic body can serve also as a sealing member for a mounting portion of the temperature sensor.

According to the fourth embodiment of the present invention, the elastic body includes the elastic surface other than the support portion supporting the intake duct, the connecting tube, and the temperature sensor. Thus, a drop in pressure in the air cleaner can be reliably suppressed by the elastic surface other than the support portion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side elevational view showing a vehicle that adopts an air cleaner structure according to an embodiment of the present invention;

FIG. 2 is a plan view showing the vehicle according to the embodiment of the present invention;

FIG. 3 is a principal plan view illustrating an intake system according to the embodiment of the present invention;

FIG. 4 is a perspective view showing an air cleaner and an intake duct according to the embodiment of the present invention;

FIG. 5 is a front view illustrating a connection rubber of the air cleaner according to the embodiment of the present invention;

FIG. 6 is a cross-sectional view taken along line 6-6 of FIG. 5;

FIG. 7 is a principal cross-sectional view showing the connection rubber according to the embodiment of the present invention;

FIG. 8 is a cross-sectional view taken along line 8-8 of FIG. 5;

FIG. 9 is a cross-sectional view taken along line 9-9 of FIG. 5; and

FIG. 10 is a view illustrating operation of the air cleaner structure according to the embodiment of the present invention.

### DETAILED DESCRIPTION OF THE PREFERRED EMBODIMENTS

The best mode for carrying out the present invention will be described below with reference to the accompanying drawings. The drawings should be viewed in the direction of reference symbols.

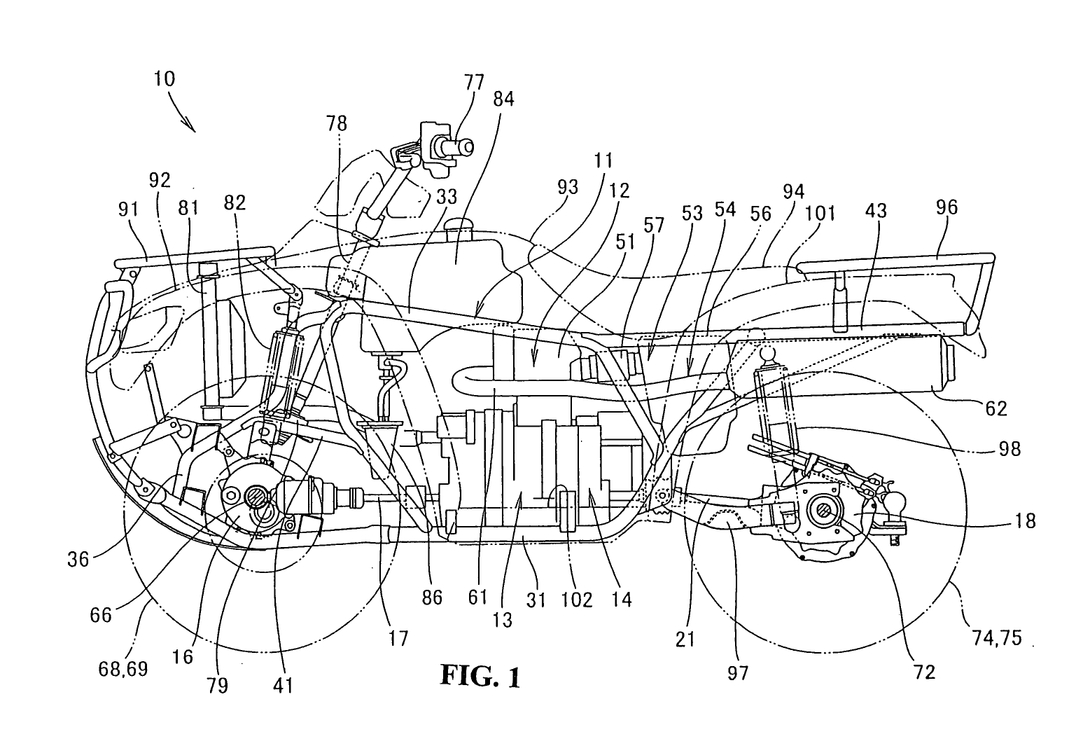

FIG. 1 is a side elevational view showing a vehicle that adopts an air cleaner structure according to an embodiment of the present invention. A vehicle 10 is a four-wheel-drive, all terrain vehicle (ATV). The vehicle 10 includes a power unit 14 disposed substantially at a center of a vehicle body frame 11. The power unit 14 includes a longitudinal engine 12 and a transmission 13. A front propeller shaft 17 connects a front final assembly 16 disposed forward of the power unit 14 to the transmission 13. A rear propeller shaft 21 connects a rear final assembly 18 disposed rearward of the power unit 14 to the transmission 13.

The vehicle body frame 11 includes a pair of left and right lower frames 31, 32 (only reference numeral 31 representing the lower frame on a proximal side is shown), a pair of left and right upper frames 33, 34 (only reference numeral 33 representing the upper frame on the proximal side is shown), a pair of left and right front frames 36, 37 (only reference numeral 36 representing the front frame on a proximal side is shown), a pair of left and right front connection frames 41, 42 (only reference numeral 41 representing the front connection frame on the proximal side is shown), and a pair of left and right rear upper frames 43, 44 (only reference numeral 43 representing the rear upper frame on the proximal side is shown). More specifically, the lower frames 31, 32 support a lower portion of the power unit 14. The upper frames 33, 34 are substantially C-shaped, and are disposed at an upper portion of the lower frames 31, 32 so as to enclose the power unit 14 in a side view. The front frames 36, 37 connect upper portions at a front of the upper frames 33, 34 and front end portions of the lower frames 31, 32, respectively. The front connection frames 41, 42 connect the front frames 36, 37 and the upper frames 33, 34, respectively. The rear upper frames 43, 44 extend rearwardly from upper rear portions of the upper frames 33, 34. The rear upper frames 43, 44 have intermediate portions connected to rear ends of the lower frames 31, 32.

The engine 12 includes a cylinder portion 51, to which an intake system 53 and an exhaust system 54 are connected. The intake system 53 includes an air cleaner 56 and a throttle body 57. The exhaust system 54 includes an exhaust pipe 61 and a muffler 62.

The front final assembly 16 connects to left and right front wheels 68, 69 via a pair of left and right drive shafts 66, 67 (only reference numeral 66 representing the drive shaft on the proximal side is shown).

The rear final assembly 18 connects to left and right rear wheels 74, 75 via a pair of left and right drive shafts 72, 73 (only reference numeral 72 representing the drive shaft on the proximal side is shown).

A handlebar 77 steering the front wheels 68, 69 is supported by a steering shaft 78. The steering shaft 78 has a front portion rotatably mounted on a cross pipe (not shown) disposed across front portions of the upper frames 33, 34. Further, the steering shaft 78 includes a lower portion rotatably mounted onto a cross plate 79 disposed across the front connection frames 41, 42.

In FIG. 1, a radiator 81 is provided together with a pair of left and right front shock absorber units 82, 83 (only reference numeral 82 representing the front shock absorber on the proximal side is shown). A fuel tank 84 is provided together with a fuel pump 86. A front carrier 91 is provided together with a front fender 92. A body cover 93 is provided together with a 94 represents a seat 94. A rear carrier 96 is mounted adjacent to a swing arm 97 that swingably supports the rear final assembly 18. A rear shock absorber unit 98 is disposed across the side of the rear upper frames 43, 44 and the side of the rear final assembly 18. A rear fender 101 is mounted adjacent to a step floor 102.

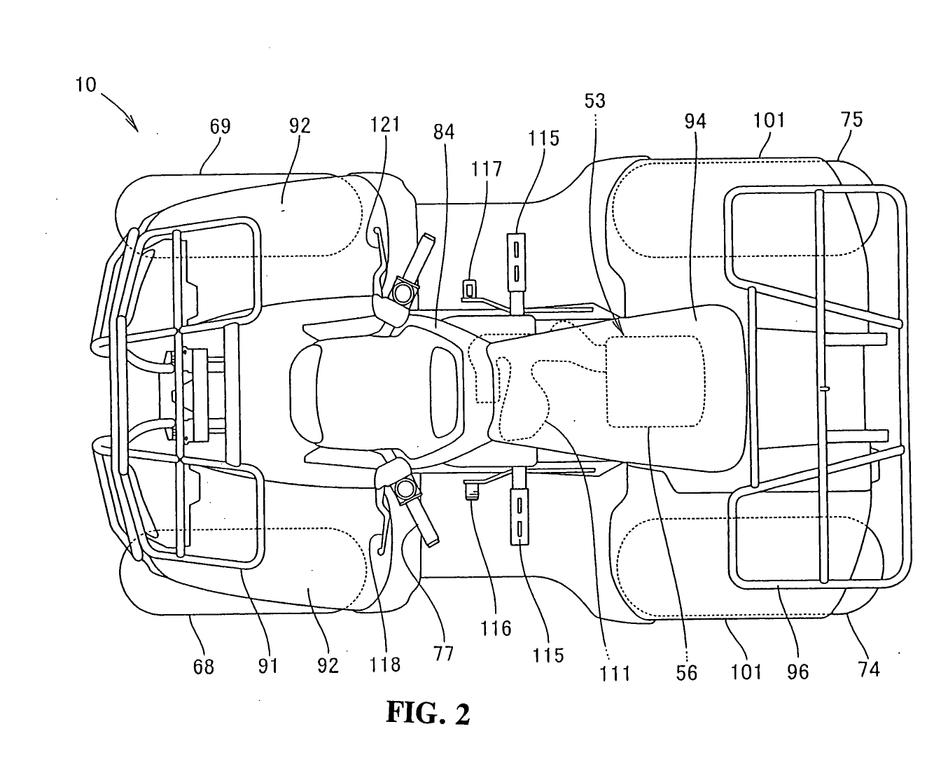

FIG. 2 is a plan view showing the vehicle according to the embodiment of the present invention. The vehicle 10 is a four-wheeled vehicle including an intake duct 111, which forms part of the intake system 53, disposed downwardly of the fuel tank 84 and the seat 94. The intake duct 111 has a rear end connected to the air cleaner 56.

In FIG. 2, occupant steps 115, 115 are provided together with a gearshift pedal 116. A brake pedal 117 is provided together with a clutch lever 118 and a brake lever 121.

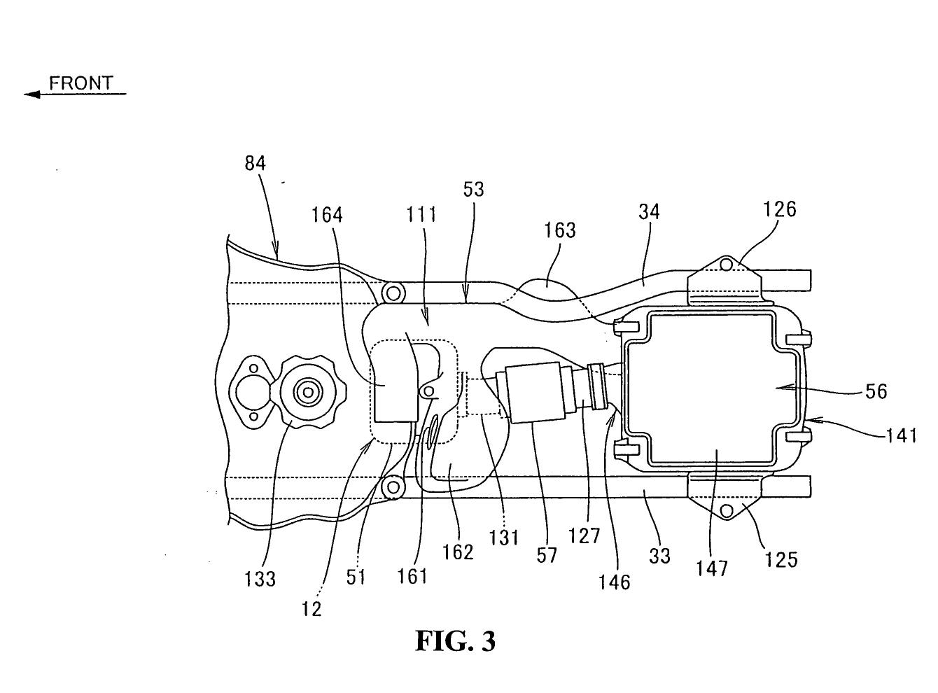

FIG. 3 is a principal plan view illustrating the intake system according to an embodiment of the present invention (the arrow (FRONT) shown in FIG. 3 indicates a forward direction of the vehicle; the same also applies hereunder). As illustrated in FIG. 3 the air cleaner 56 is mounted to the left and right upper frames 33, 34 via brackets 125, 126. A rear end of the intake duct 111 and a rear end of a connecting tube 127 are connected to a front portion of the air cleaner 56. The throttle body 57 is connected to a front end of the connecting tube 127. An intake pipe 131 is connected to a front end of the throttle body 57. Further, a front end of the intake pipe 131 is connected to the cylinder portion 51 of the engine 12. In FIG. 3, reference numeral 133 represents a filler cap of the fuel tank 84.

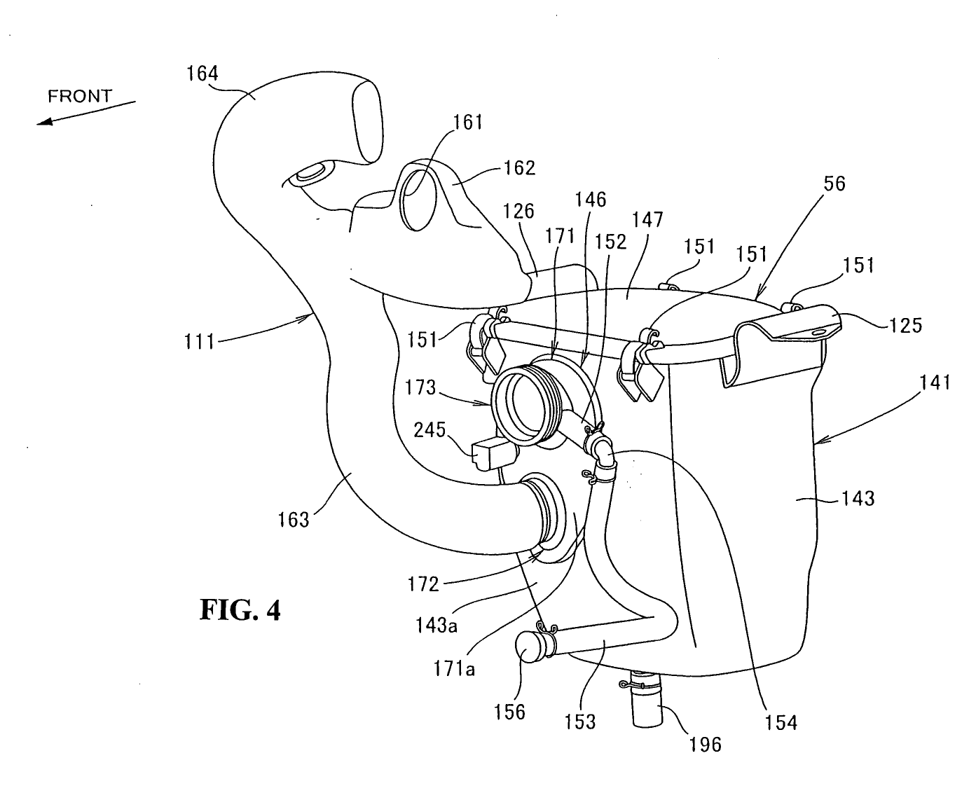

FIG. 4 is a perspective view showing the air cleaner 56 and the intake duct 111 according to an embodiment of the present invention. The air cleaner 56 includes an air cleaner case 141 and an air cleaner element (not shown) disposed inside the air cleaner case 141. The air cleaner case 141 includes a case main body 143, a connection rubber 146, and a case cover 147. The connection rubber 146 is fitted to a side wall 143a of the case main body 143 for connecting the intake duct 111 and the connecting tube 127 to the case main body 143. The case cover 147 closes an opening in an upper portion of the case main body 143. In FIG. 4, fixing brackets 151 are provided for fixing the case cover 147 to the case main body 143. A tube portion 152 is integrated with the connection rubber 146. An extension pipe 153 is connected to the tube portion 152 via a joint tube 154. A plug 156 plugs an end portion of the extension pipe 153.

The intake duct 111 includes an intake chamber 162, a duct portion 163, and a resonator 164. The intake chamber 162 includes an intake port 161, through which air is drawn in from the outside. The duct portion 163 has a first end integrally connected to the intake chamber 162 and a second end connected to a lower portion of the connection rubber 146. The resonator 164 is connected to the duct portion 163.

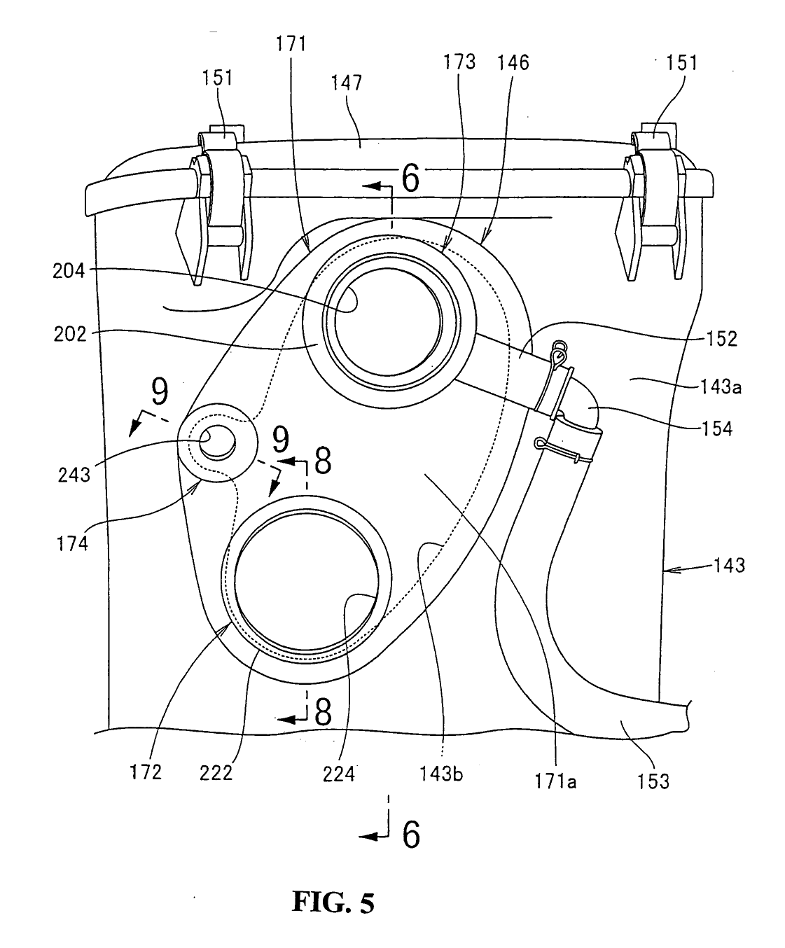

FIG. 5 is a front view illustrating the connection rubber 146 of the air cleaner 56 according to an embodiment of the present invention. The connection rubber 146 includes a sheet-like portion 171, a duct connection portion 172, a tube connection portion 173, and a sensor mounting portion 174. The sheet-like portion 171 is fitted in a mounting hole 143b made in the side wall 143a of the case main body 143. The duct connection portion 172 is integrally formed with the sheet-like portion 171 for connecting the intake duct 111 (see FIG. 4) at a lower portion of the sheet-like portion 171. The tube connection portion 173 is integrally formed with the sheet-like portion 171 for connecting the connecting tube 127 (see FIG. 3) at an upper portion of the sheet-like portion 171. The sensor mounting portion 174 is integrally formed with the sheet-like portion 171 for mounting a temperature sensor at an edge portion of the sheet-like portion 171 on a side close to the duct connection portion 172.

The sheet-like portion 171 includes a flat portion 171a disposed inside the mounting hole 143b and surrounded by the duct connection portion 172, the tube connection portion 173, and the sensor mounting portion 174. The flat portion 171a is elastically deformed to a greater extent than other portions such that the sheet-like portion 171 can make a small change in pressure, or in particular, a pressure drop. The sheet-like portion 171 is provided with a large area so as to be easily deformed elastically.

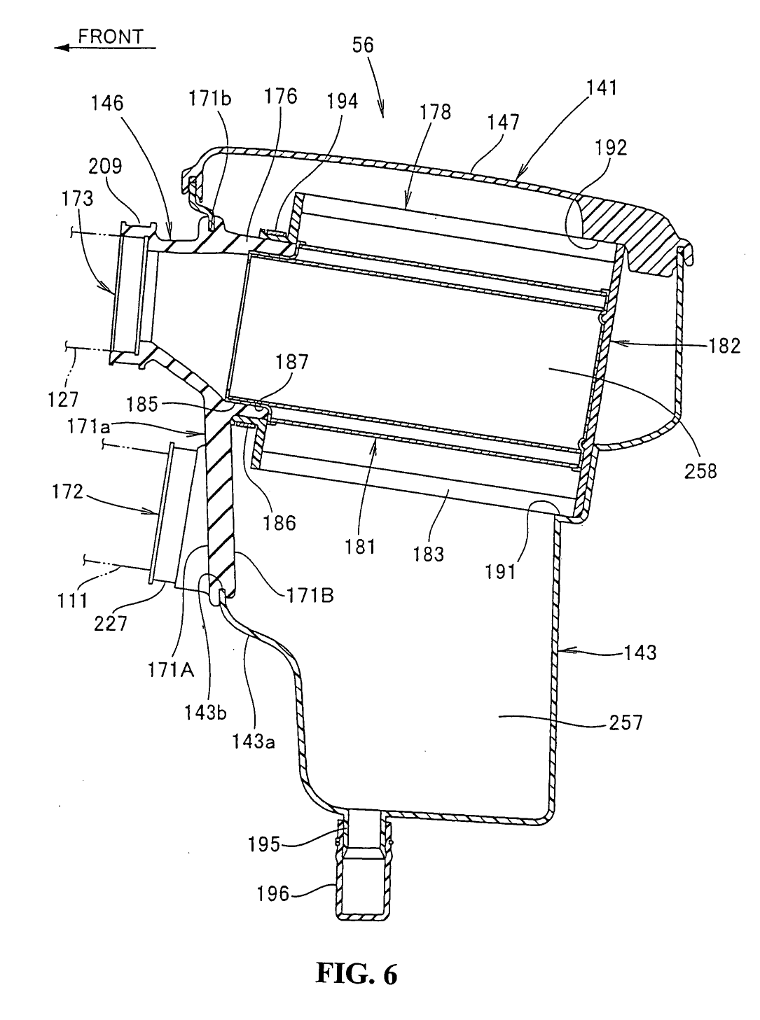

FIG. 6 is a cross-sectional view taken along line 6-6 of FIG. 5. As illustrated in FIG. 6, the connection rubber 146 is fitted in the mounting hole 143b in the case main body 143. An air cleaner element 178 is supported by an inner pipe portion 176 disposed inside the sheet-like portion 171 of the connection rubber 146 and the air cleaner case 141. As illustrated in FIG. 6, an annular groove portion 171b is disposed in a peripheral edge of the sheet-like portion 171. An outer surface 171A of the flat portion 171a of the sheet-like portion 171 is provided together with an inner surface 171B of the flat portion 171a of the sheet-like portion 171.

The air cleaner element 178 includes a frame 181 and a filter assembly 182. More specifically, the frame 181 includes a plurality of metal plate members. The filter assembly 182 is fitted to the frame 181. The filter assembly 182 includes a filter 183.

The air cleaner element 178 is secured in position as described below. More specifically, the frame 181 includes an inner tube portion 185. The filter assembly 182 includes an outer tube portion 186. The inner tube portion 176 of the connection rubber 146 is then fitted into an annular groove 187 formed between the inner tube portion 185 and the outer tube portion 186. The case main body 143 includes a step portion 191. The case cover 147 includes a rising wall 192 having an L-shaped cross section. The step portion 191 and the rising wall 192 clamp an end portion of the filter assembly 182 of the air cleaner element 178. The air cleaner element 178 is thereby supported by the inner tube portion 176 of the connection rubber 146 and the air cleaner case 141. In FIG. 6, a hose band 194 is provided that tightens the outer tube portion 186, the inner pipe portion 176, and the inner tube portion 185. A drain pipe 195 is disposed on a bottom portion of the case main body 143 with a rubber cap 196 that plugs an opening at a lower portion of the drain pipe 195.

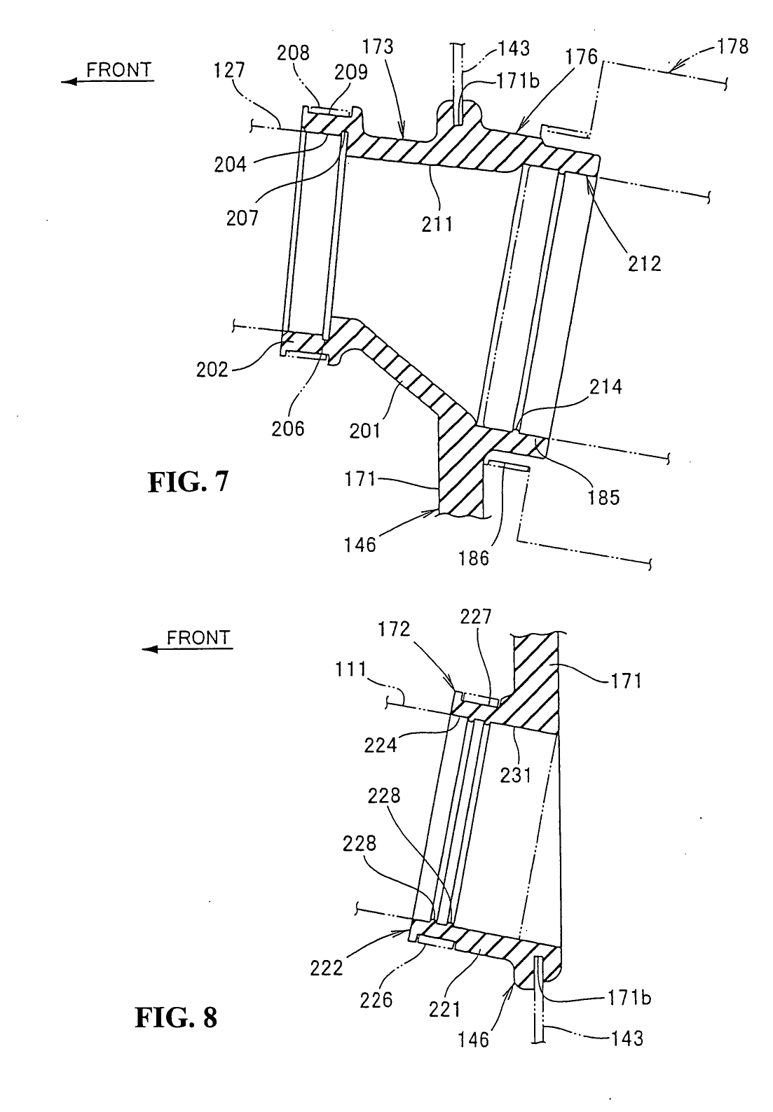

FIG. 7 is a principal cross-sectional view showing the connection rubber 146 according to the embodiment of the present invention. More specifically, FIG. 7 is a cross-sectional view showing the tube connection portion 173.

The tube connection portion 173 includes an upper portion pipe portion 201 and an upper portion connection main body portion 202. The upper portion pipe portion 201 projects integrally from the sheet-like portion 171. The upper portion connection main body portion 202 is disposed integrally at a leading end of the upper portion pipe portion 201.

The upper portion pipe portion 201 includes a connection hole 204, an inner annular groove 207, and an annular band groove 209. The connection hole 204 receives the connecting tube 127 inserted therein. The inner annular groove 207 is disposed in a back side of the connection hole 204. A flange 206 formed at a leading end of the connecting tube 127 is fitted into this inner annular groove 207. The band groove 209 includes a portion tightened by a hose band 208. The upper portion pipe portion 201 communicates the connection hole 204 and the inner annular groove 207 with a hollow portion 211 of the upper portion pipe portion 201, a hollow portion 212 of the inner pipe portion 176, and the air cleaner case 141 (see FIG. 6), more specifically, an inside of the case main body 143. In FIG. 7, an annular projection 214 is formed in the hollow portion 212. The annular projection 214 provides sealing with respect to the inner tube portion 185 of the air cleaner element 178.

FIG. 8 is a cross-sectional view taken along line 8-8 of FIG. 5. The duct connection portion 172 includes a lower portion pipe portion 221 and a lower portion connection main body portion 222. The lower portion pipe portion 221 projects integrally from the sheet-like portion 171. The lower portion connection main body portion 222 is integrally formed with the lower portion pipe portion 221 at a leading end portion of the lower portion pipe portion 221. Further, the lower portion connection main body portion 222 includes a connection hole 224 and an annular band groove 227. The connection hole 224 receives the intake duct 111 inserted therein. The band groove 227 is tightened by a hose band 226. The connection hole 224 includes two annular projections 228, 228 for improving the sealing performance relative to the intake duct 111. The duct connection portion 172 communicates the connection hole 224 with a hollow portion of the lower portion pipe portion 221 and the air cleaner case 141 (see FIG. 6), more specifically, the inside of the case main body 143.

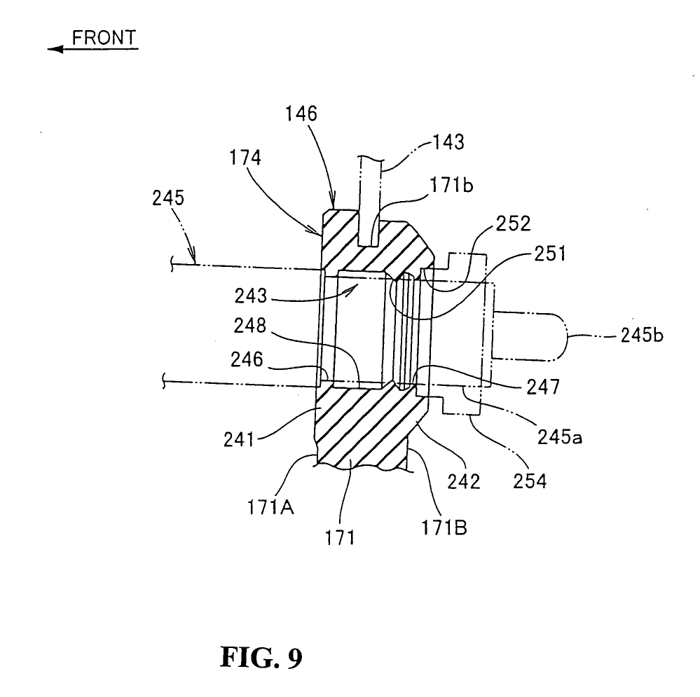

FIG. 9 is a cross-sectional view taken along line 9-9 of FIG. 5. The sensor mounting portion 174 includes an outer bulged portion 241, an inner bulged portion 242, and a hole portion 243. The outer bulged portion 241 is bulged from the outer surface 171A of the sheet-like portion 171. The inner bulged portion 242 is bulged from the inner surface 171B of the sheet-like portion 171. The hole portion 243 penetrates through an area from the outer bulged portion 241 to the inner bulged portion 242.

The hole portion 243 includes fitting holes 246, 247, a large diameter hole 248, an annular peak portion 251, and an inner hole portion 252. A temperature sensor 245 is inserted and fitted in the fitting holes 246, 247. The large diameter hole 248 is disposed between the fitting holes 246, 247 and has a diameter larger than those of the fitting holes 246, 247. The annular peak portion 251 is formed to project inwardly from the large diameter hole 248. The inner hole portion 252 is disposed adjacent a first fitting hole 247, formed in the inner bulged portion 242.

The temperature sensor 245 is mounted to the sensor mounting portion 174 as detailed below. More specifically, the temperature sensor 245 is inserted into the hole portion 243 and a nut 254 is screwed onto an external thread portion 245a formed on the temperature sensor 245.

The annular peak portion 251 in the hole portion 243 is smaller in inner diameter than the fitting holes 246, 247. Accordingly, when the temperature sensor 245 is inserted into the hole portion 243, the annular peak portion 251 is compressed so as to provide sealing between the hole portion 243 and the temperature sensor 245. As illustrated in FIG. 9, a detector portion 245b of the temperature sensor 245 is provided.

Effects of the air cleaner structure described heretofore will be described below.

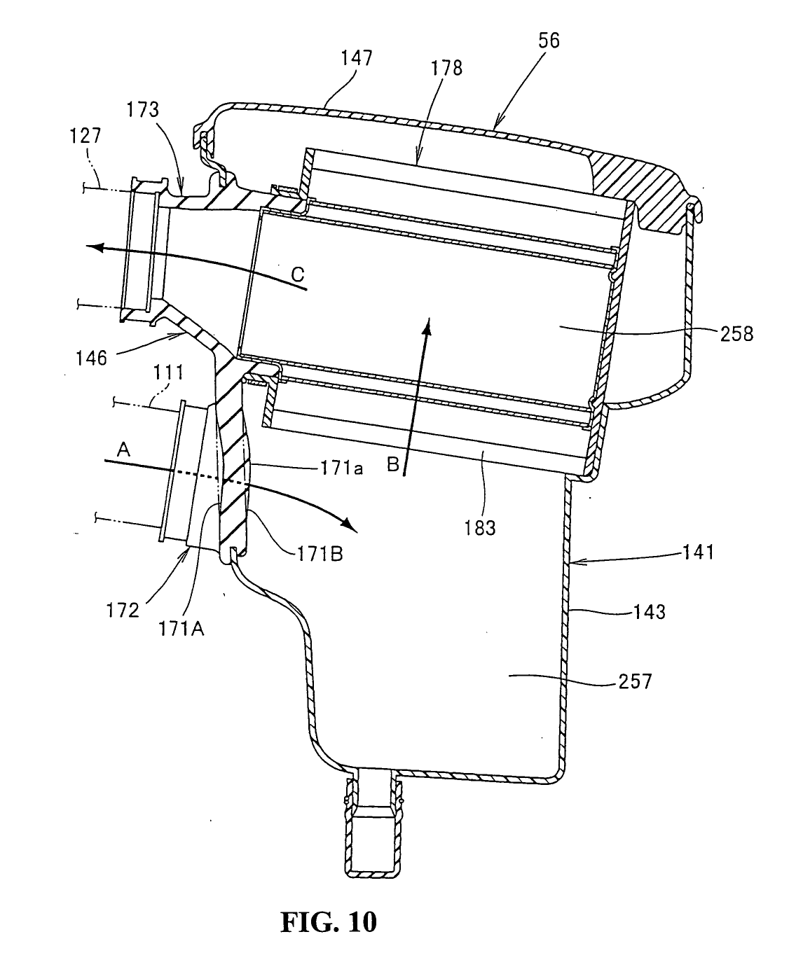

FIG. 10 is a view illustrating the operation of the air cleaner structure according to the embodiment of the present invention.

If, for example, a throttle grip is suddenly operated in an attempt to accelerate the vehicle, air flows in the air cleaner case 141, that is, a dirty side 257, from the intake duct 111 via the duct connection portion 172 of the air cleaner 56 as shown by an arrow A. The air is then purified by the filter 183 and flows in the air cleaner element 178, that is, a clean side 258 as shown by an arrow B. The air further flows in the connecting tube 127 via the tube connection portion 173 as shown by an arrow C. Referring back to FIG. 3, the air flows through the throttle body 57 and the intake pipe 131 to reach the cylinder portion 51 of the engine 12.

Referring to FIG. 10, suction from the side of the engine 12 and air flow resistance of the intake duct 111, the duct connection portion 172, and the air cleaner element 178 act, at this time, to drop a pressure on the dirty side 257 and the clean side 258. The drop in pressure flexes the flat portion 171a of the connection rubber 146 inwardly and, as a result, the drop in pressure on the dirty side 257 and the clean side 258 is minimized. Consequently, the air on the dirty side 257 and the clean side 258 is not prevented from flowing toward the side of the engine 12.

If, for example, the pressure drop on the dirty side 257 and the clean side 258 is large, the decreased low pressure makes the flow of air to the engine side less smooth. In accordance with an embodiment of the present invention, however, the small drop in pressure ensures a smooth flow of air to the engine side. As a result, a large volume of air can be supplied to the engine 12 instantaneously, allowing an output of the engine 12 to be increased instantaneously. Thus, the response of the engine 12 to increase the engine speed when a throttle valve is suddenly opened, that is, the throttle response can therefore be improved.

As described heretofore with reference to FIGS. 1 and 6, according to the first embodiment of the present invention, the air cleaner structure for the vehicle 10 is provided, in which the air cleaner 56 is mounted to the vehicle body frame 11 and the air cleaner includes the intake duct 111 for drawing air in the air cleaner 56 and the connecting tube 127 (see FIG. 3) for providing communication between the air cleaner 56 and the side of the engine 12. The intake duct 111 and the connecting tube 56 are connected to the air cleaner 56. The air cleaner structure according to the first aspect of the present invention is characterized in that the air cleaner 56 includes the connection rubber 146 as the elastic body capable of being flexed by a change in pressure in the air cleaner 56. The connection rubber 146 is disposed on the side wall 143a as at least one of the walls of the air cleaner 56.

As a result, if, for example, the throttle valve is suddenly opened, the connection rubber 146, or more specifically, the flat portion 171a of the sheet-like portion 171 suppresses an instantaneous drop in pressure in the air cleaner 56. This allows air to be quickly drawn into the engine 12, thus improving throttle response.

The air cleaner structure according to the second embodiment of the present invention is characterized in that the intake duct 111 and the connecting tube 127 are supported by the single connection rubber 146.

As a result, the connection rubber 146 supporting the intake duct 111 and the connecting tube 127 can be mounted to the air cleaner 56 at one time, as compared with an arrangement, in which an intake duct connection rubber and a connecting tube connection rubber are separately provided. Thus, the assemblability can therefore be improved and productivity enhanced.

Referring to FIGS. 4 and 9, the air cleaner structure according to the third embodiment of the present invention is characterized in that the vehicle 10 (see FIG. 1) includes the temperature sensor 245 that measures the intake air temperature of the air cleaner 56 and the temperature sensor 245 is supported by the connection rubber 146.

This improves assemblability of the temperature sensor 245 relative to the air cleaner 56 and prevents vibration from being transmitted to the temperature sensor 245, as compared with an arrangement, in which a temperature sensor connection rubber is separately provided. Further, the connection rubber 146 can serve also as a sealing member for the sensor mounting portion 174.

Referring to FIGS. 5 and 6, the air cleaner structure according to the fourth embodiment of the present invention is characterized in that the connection rubber 146 includes the outer surface 171A and the inner surface 171B of the flat portion 171a as an elastic surface other than the duct connection portion 172 and the tube connection portion 173. The sensor mounting portion 174 serves as the support portion supporting the intake duct 111, the connecting tube 127, and the temperature sensor 245 (see FIG. 9).

As a result, the outer surface 171A and the inner surface 171B other than the support portions 172 to 174 flex to reliably suppress a drop in pressure in the air cleaner 56.

In addition, the connection rubber 146 includes the flat portion 171a. This helps decrease the number of parts used and the cost, as compared with an arrangement, in which the flat portion is provided as a separate body from the connection rubber.

In accordance with the embodiment of the present invention, the sheet-like portion 171 includes the flat portion 171a disposed in an area of the connection rubber 146 surrounded by the duct connection portion 172, the tube connection portion 173, and the sensor mounting portion 174. The arrangement is not limited to this; rather, the flat portion may be disposed inside the mounting hole 143b and outside the duct connection portion 172, the tube connection portion 173, or the sensor mounting portion 174.

The air cleaner structure according to the embodiment of the present invention is preferably applicable to a two-wheeled vehicle of a four-wheeled vehicle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An air cleaner structure for a vehicle, comprising:
an air cleaner disposed on a vehicle body frame, the air cleaner including an intake duct for drawing air into the air cleaner and a connecting tube for providing communication between the air cleaner and an engine side, the intake duct and the connecting tube being connected to the air cleaner,
wherein the air cleaner includes an elastic body capable of being flexed by a change in pressure in the air cleaner, the elastic body being disposed on at least one wall of the air cleaner.

2. The air cleaner structure according to claim 1, wherein the intake duct and the connecting tube are supported by a single elastic body.

3. The air cleaner structure according to claim 1, wherein the air cleaner of the vehicle includes a temperature sensor measuring a temperature of air drawn into the air cleaner, said temperature sensor being supported by the elastic body.

4. The air cleaner structure according to claim 2, wherein the air cleaner of the vehicle includes a temperature sensor measuring a temperature of air drawn into the air cleaner, said temperature sensor being supported by the elastic body.

5. The air cleaner structure according to claim 1, wherein the elastic body includes an elastic surface other than a support portion supporting the intake duct, the includes an elastic surface other than a support portion supporting the intake duct, the connecting tube, and the temperature sensor.

6. The air cleaner structure according to claim 2, wherein the elastic body includes an elastic surface other than a support portion supporting the intake duct, the connecting tube, and the temperature sensor.

7. The air cleaner structure according to claim 3, wherein the elastic body includes an elastic surface other than a support portion supporting the intake duct, the connecting tube, and the temperature sensor.

8. An air cleaner structure adapted to be used with a vehicle, comprising:
an air cleaner including an intake duct for drawing air into the air cleaner and a connecting tube for providing communication between the air cleaner and an engine side,
an elastic body operatively connected to said air cleaner, said elastic body being disposed on at least one of wall of the air cleaner and being capable of being flexed by a change in pressure in the air cleaner.

9. The air cleaner structure according to claim 8, wherein the intake duct and the connecting tube are supported by a single elastic body.

10. The air cleaner structure according to claim 8, wherein the air cleaner of the vehicle includes a temperature sensor measuring a temperature of air drawn into the air cleaner, said temperature sensor being supported by the elastic body.

11. The air cleaner structure according to claim 9, wherein the air cleaner of the vehicle includes a temperature sensor measuring a temperature of air drawn into the air cleaner, said temperature sensor being supported by the elastic body.

12. The air cleaner structure according to claim 8, wherein the elastic body includes an elastic surface other than a support portion supporting the intake duct, the connecting tube, and the temperature sensor.

13. The air cleaner structure according to claim 9, wherein the elastic body includes an elastic surface other than a support portion supporting the intake duct, the connecting tube, and the temperature sensor.

14. The air cleaner structure according to claim 10, wherein the elastic body includes an elastic surface other than a support portion supporting the intake duct, the connecting tube, and the temperature sensor.

15. An air cleaner structure, comprising:
an air cleaner including an intake duct for drawing air into the air cleaner;
a connecting tube for discharging air from the air cleaner; said intake duct and said connecting tube being operatively connected to the air cleaner;
an elastic body capable of being flexed by a change in pressure in the air cleaner, said elastic body being disposed on at least one wall of the air cleaner.

16. The air cleaner structure according to claim 15, wherein the intake duct and the connecting tube are supported by a single elastic body.

17. The air cleaner structure according to claim 15, wherein the air cleaner of the vehicle includes a temperature sensor measuring a temperature of air drawn into the air cleaner, said temperature sensor being supported by the elastic body.

18. The air cleaner structure according to claim 16, wherein the air cleaner of the vehicle includes a temperature sensor measuring a temperature of air drawn into the air cleaner, said temperature sensor being supported by the elastic body.

19. The air cleaner structure according to claim 15, wherein the elastic body includes an elastic surface other than a support portion supporting the intake duct, the connecting tube, and the temperature sensor.

20. The air cleaner structure according to claim 16, wherein the elastic body includes an elastic surface other than a support portion supporting the intake duct, the connecting tube, and the temperature sensor.
